(19) United States
(12) Patent Application Publication
(10) Pub. No.: US 2011/0179744 A1
(43) Pub. Date: Jul. 28, 2011

(54) SAFETY SYSTEM

(76) Inventor: Gordon Smith, Kilharnock (GB)

(21) Appl. No.: 12/518,057

(22) PCT Filed: Dec. 5, 2007
(86) PCT No.: PCT/GB2007/004656

§ 371 Date: Apr. 8, 2011

(30) Foreign Application Priority Data
Dec. 5, 2006 (GB) 0624291.1
Jun. 8, 2007 (GB) 0711058.8

(51) Int. Cl. E04G 21/32; E04G 21/14; E04H 17/26; E04H 17/14; F16M 13/02; G01B 1/00

(52) U.S. Cl. 52/745.05; 256/65.14; 256/59; 248/205.1; 33/645

(57) ABSTRACT

An apparatus and a method for providing edge protection for timber kit erections is provided in which fixing brackets (103, 105) are attached to a floor cassette (71) or to the top of a wall panel (67), into which a guard assembly (121) is inserted. When edge protection is no longer required the guard assembly is subsequently removed, for example by use of a sling and shackle. Typically, the edge protection is put in place before the floor cassette is lifted into position on the timber kit erection. Vertical members, horizontal members, and fixing brackets for the same are also provided. In addition, an edge locating apparatus, and a corresponding method for locating an upper section of timber kit onto a lower section of timber kit, is provided having a sloping portion to guide the upper section onto lower section.

The present invention relates to an apparatus and a method for providing a safety system, in particular, an edge protection system and method for timber kit erections.

In the field of construction, scaffolding is used to assist not only in the erection of structures but also as a safety system which prevents workers from falling from the sides of buildings etc.

In particular, edge protection is necessary when erecting timber kit structures, and is generally provided by scaffolding as mentioned. Scaffolding is modular and provides a rigid perimeter within which and (if applicable) against which the structure can be erected. An arrangement of kick plates, boards and cross members can be constructed to provide a safe working environment for the workers on-site.

The drawback of using scaffolding is that construction of the scaffold framework itself is a skilled task and can take quite a long time to erect properly. Furthermore, while waiting for the scaffold framework to be assembled, work on the structure itself can only be pursued up to a safe working height. In timber kit erections, this working height can be reached very quickly as the structure is assembled using a variety of pre-made modular components.

Reliance on scaffolding to, as an example, provide the required safety for commencement of construction of the upper floors and roof of a two-storey house, means that any delays or significant time spent in assembly of the scaffolding will result in delays in constructing the house. In short, time spent erecting scaffolding is time wasted in building the house.

Furthermore, purchase or hire of scaffolding and any necessary skilled labour entails further costs which must be factored into the price of building, to continue the example, a two storey house. There may also be delays in delivery, and the often limited availability of scaffolding means that complete scaffold erections are not always possible in the timescales desired.

In addition, to accommodate a number of different trades (e.g. joiners/kit erectors, bricklayers, glazers etc.) scaffold hop ups may need to be altered on as many as three or four occasions, resulting in further delays. It is also common that scaffolding will be vandalised or otherwise altered by unauthorised persons during the time it is in place.

It is therefore an object of the present invention to provide an apparatus and a method that overcomes one or more of the disadvantages and limitations of the prior art.

According to a first aspect of the present invention, there is provided an edge protection apparatus for timber kit erections, the edge protection apparatus comprising:
one or more fixing brackets; and
a guard assembly;
wherein the one or more fixing brackets are adapted to be located at or near an upper end of a wall panel of the timber kit; and
the one or more fixing brackets further adapted to removeably locate the guard assembly.

The guard assembly is therefore able to be temporarily located in a fixed position at or near the top of a wall panel and provide edge protection to allow work to continue at the level of the top of the wall panel, and subsequently removed.

Most preferably, the one or more fixing brackets are adapted to be located on an outer face of a floor panel of the timber kit.

Preferably, the one or more fixing brackets are adapted to be fixedly located at or near an upper end of a wall panel of the timber kit.

The floor panel rests on top of one or more wall panels and the present invention can therefore provide edge protection for construction to commence upwards of the floor kit and wall panels.

Alternatively, the one or more fixing brackets are adapted to be fixedly located at or near an upper end of a wall panel of the timber kit.

Preferably, the guard assembly comprises two or more upright members and one or more horizontal members disposed therebetween.

Optionally, the one or more fixing brackets are integrally formed with the guard assembly.

Optionally, the one or more fixing brackets comprise a clamp.

Preferably, the two or more upright members each comprise one or more horizontal member locating means adapted to removably locate the one or more horizontal members therebetween.

Most preferably, the two or more upright members each comprise three horizontal member locating means separated so as to locate three horizontal members therebetween with a vertical spacing of 500 mm.

Optionally, the one or more horizontal member locating means are moveable so as to adjust the separation between neighbouring horizontal members.

Preferably, the upright members are tubular.

Preferably, the upright members are circular in cross section.

Alternatively, the upright members are rectangular in cross section.

Preferably, the horizontal members are tubular.

Preferably, the horizontal members are circular in cross section.

Alternatively, the horizontal members are rectangular in cross section.

Preferably, the horizontal member locating means are tubular.

Preferably, the horizontal member locating means are circular in cross section.

Alternatively, the horizontal member locating means are rectangular in cross section.

Further alternatively, the horizontal member locating means are L-shaped in cross section so as to form a channel between the horizontal member locating means and the vertical member.

Preferably, the channel is open at an upper end thereof so as to allow removal of the horizontal member.

Preferably, the upright members are comprised of steel.

Preferably, the horizontal members are comprised of aluminium.

Alternatively, the horizontal members are comprised of timber.

Preferably, the guard assembly further comprises a sling and shackle assembly arranged to permit lifting of the guard assembly by a crane.

Alternatively, the guard assembly comprises a continuous material sheet.

Preferably, the material is selected from the group of metal, wood, and plastics materials.

Alternatively, the guard assembly comprises a supported mesh.

Preferably, each of the fixing brackets comprises an upright member locating means adapted to receive an upright member of the guard assembly.

Preferably, the upright member locating means is tubular.

Preferably, the upright member locating means is circular in cross section.

Alternatively, the upright member locating means is rectangular in cross section.

Preferably, each of the fixing brackets comprises a plate to which the upright member locating means is attached, the plate having timber kit locating means adapted to fixedly locate the fixing bracket on a timber kit.

Preferably, each of the fixing brackets further comprises a spacer between the plate and the upright member locating means.

According to a second aspect of the present invention, there is provided a vertical member adapted for use in the first aspect.

According to a third aspect of the present invention, there is provided a fixing bracket adapted for use in the first aspect.

According to a fourth aspect of the present invention, there is provided a horizontal member adapted for use in the first aspect.

According to a fifth aspect of the present invention, there is provided a method for providing edge protection for a timber kit erection using the apparatus of the first aspect, the method comprising locating the guard assembly at or near an upper end of a wall panel of the timber kit.

Preferably, locating the guard assembly at or near an upper end of a wall panel of the timber kit comprises fixedly locating the fixing brackets on an outer face of a timber kit floor panel.

Preferably, locating the guard assembly at or near an upper end of a wall panel of the timber kit further comprises locating the floor panel above the wall panel.

Alternatively, locating the guard assembly at or near an upper end of a wall panel of the timber kit comprises fixedly locating the fixing brackets at or near the top of a timber kit wall panel.

Preferably, the method further comprises the step of attaching a sling and shackle assembly to the guard assembly.

Optionally, locating the guard assembly comprises the step of lifting the guard assembly using the sling and shackle assembly.

Optionally, the method further comprises the step of assembling the guard assembly.

Alternatively, locating the guard assembly comprises locating vertical members in the fixing brackets, and locating horizontal members therebetween.

According to a sixth aspect of the present invention there is provided an edge locator for locating an upper section of a timber kit erection on a lower section of a timber kit erection, the edge locator comprising:
a support section; and
a sloping section;
the support section for attachment to the lower section of the timber kit erection and the sloping section adapted to extend above the lower section of the timber kit erection and guide the upper section onto the lower section as it is lowered.

Preferably, the upper section is a roof section.

Alternatively, the upper section is a floor panel.

Preferably, the support section comprises an L-shaped cross section.

Preferably, the sloping section comprises an L-shaped cross section.

Preferably, the sloping section is integrally formed with the support section.

Preferably, the support section is adapted to fixedly locate on the lower section of the timber kit erection.

Preferably, the sloping section is adapted to correspond with a sloping inner surface of a roof.

Alternatively, the sloping section is adapted to engage a corresponding inner surface of a roof.

According to a seventh aspect of the present invention, there is provided a method for locating an upper section on a lower section of a timber kit erection using the edge locator of the sixth aspect, the method comprising the steps of:
fixedly locating one or more edge locators at or near the corners of the lower section of the timber kit erection; and
lowering the upper section onto the one or more edge locators so as to guide the upper section onto the lower section of the timber kit erection.

Preferably, the method further comprises the step of removing the edge locators when the upper section is in place.

Preferably, the edge locators are positioned such that the sloping sections thereof extend from the corners of the lower section of the timber kit erection.

Preferably, lowering the upper section onto the one or more edge locators comprises one or more inner surfaces of the upper section engaging corresponding sloping surfaces of the one or more edge locators.

The present invention will now be described by way of example only and with reference to the accompanying figures in which . . . .

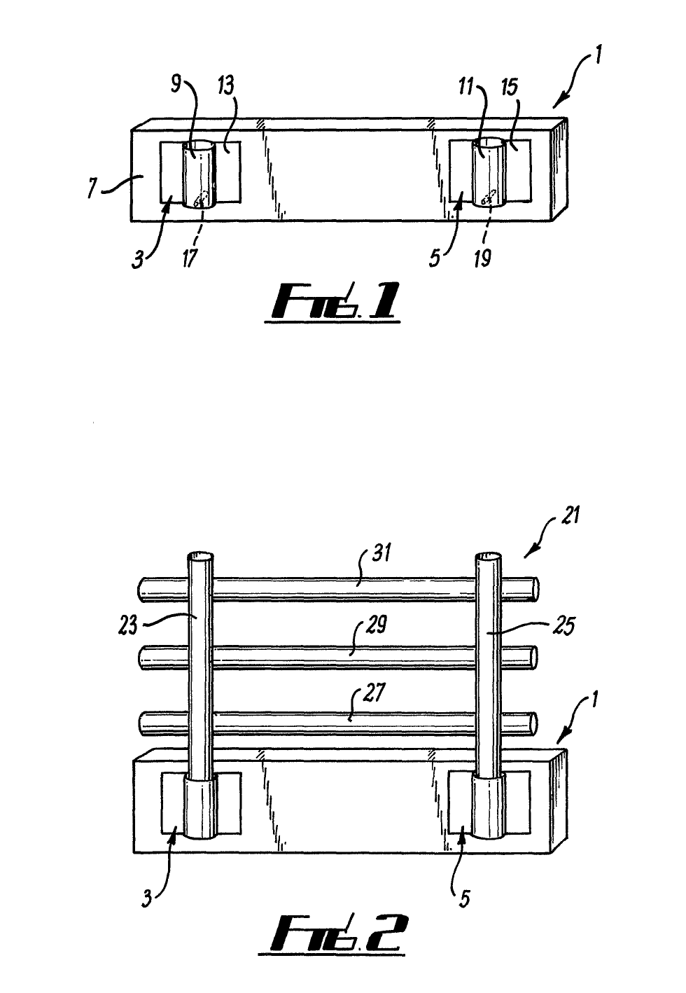

FIG. 1 illustrates in schematic form the side face of a floor panel in accordance with the present invention;

FIG. 2 illustrates in schematic form the side face of a floor panel with edge protection in place in accordance with the present invention;

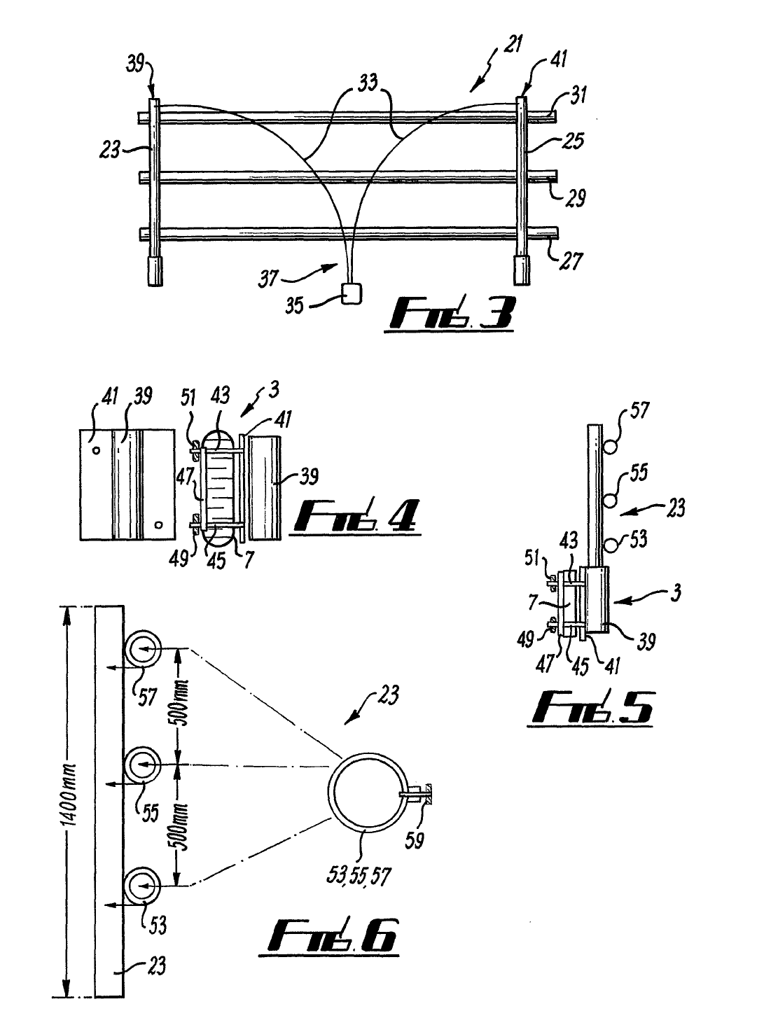

FIG. 3 illustrates in schematic form a guard assembly in accordance with the present invention;

FIG. 4 illustrates in schematic form a fixing bracket in accordance with the present invention;

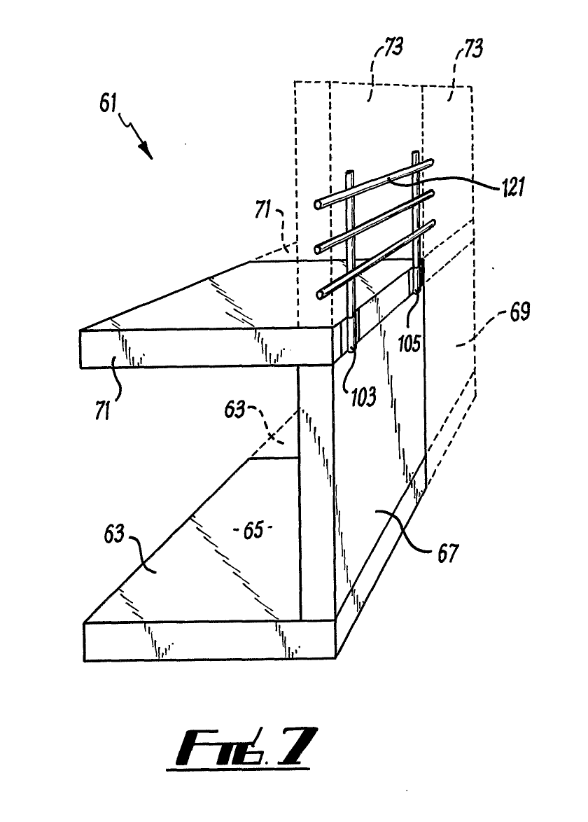

FIG. 5 illustrates in schematic form a side view of a vertical member located in a fixing bracket in accordance with the present invention;

FIG. 6 illustrates in schematic form a side and a top view of the vertical member in accordance with the present invention;

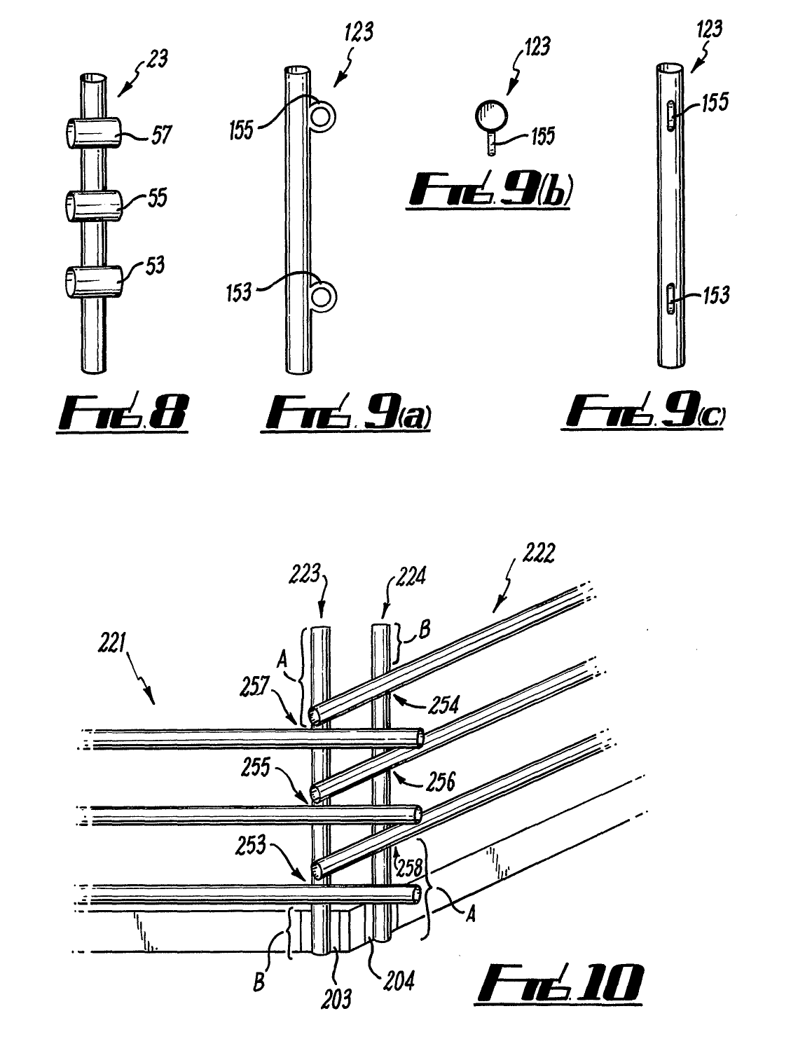

FIG. 7 illustrates in schematic form a timber kit assembly with edge protection provided in accordance with the present invention;

FIG. 8 illustrates in schematic form a front view of a vertical member in accordance with the present invention;

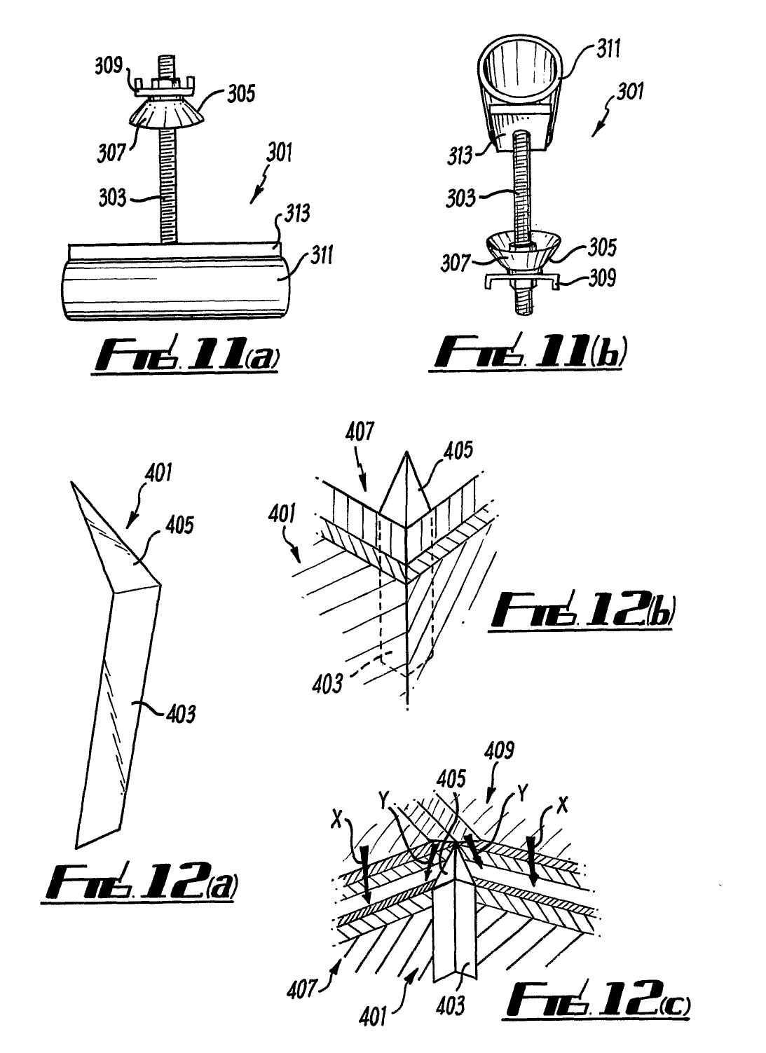

FIG. 9 illustrates in schematic form a side, a front and a top view of an alternative vertical member in accordance with the present invention;

FIG. 10 illustrates in schematic form two guard assemblies overlapping at a corner in accordance with the present invention;

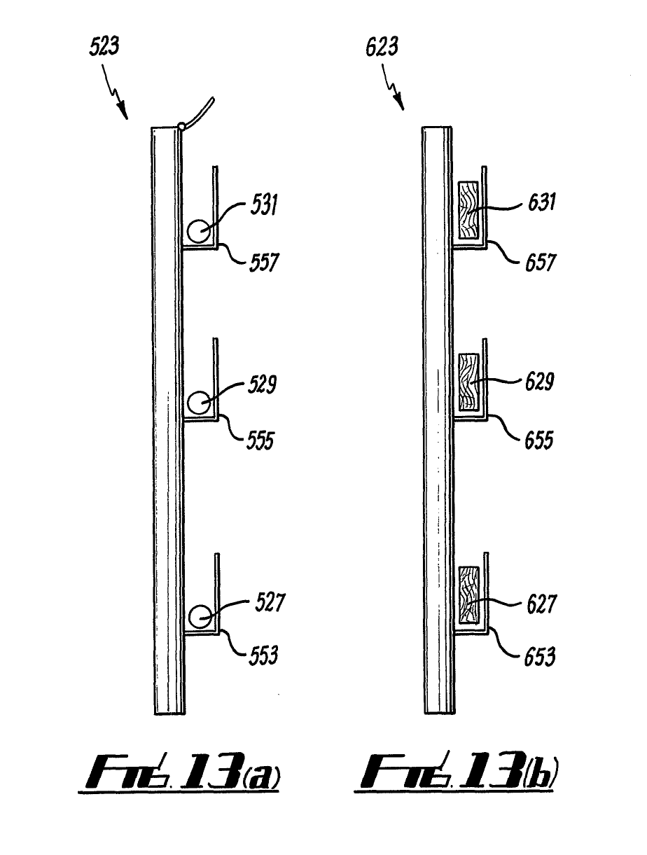

FIG. 11 illustrates in schematic form an alternative fixing bracket in accordance with the present invention;

FIG. 12 illustrates in schematic form a roof edge locator in accordance with the present invention;

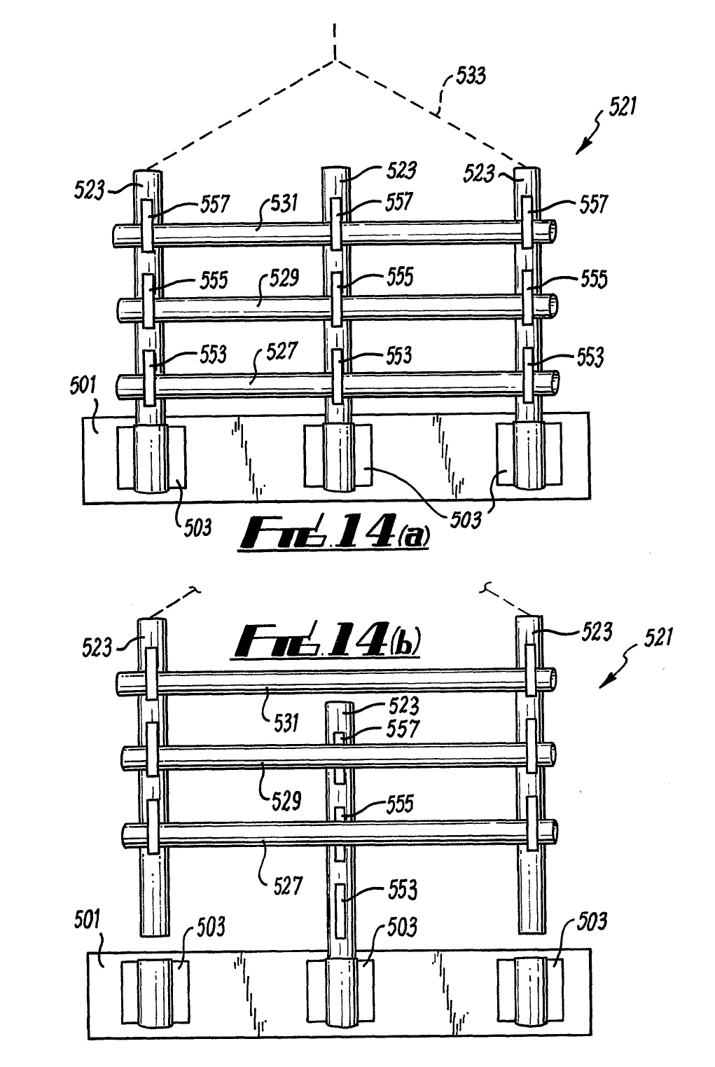

FIG. 13 illustrates in schematic form an alternative vertical member in accordance with the present invention; and

FIG. 14 illustrates in schematic form the removal of a guard assembly comprising vertical members as shown in FIG. 13, in accordance with the present invention.

FIG. 1 illustrates a floor (or ceiling) panel 1 which is part of a timber kit assembly. Such a panel might be the floor or ceiling of a timber kit two-storey house, or a floor cassette as known in the art. Two fixing brackets 3,5 are bolted onto the side face 7 of the floor panel 1. The brackets 3,5 have tubular locating means 9,11 welded to steel plates 13,15 which allow vertical members of a guard assembly to locate therein and thus be held upright in place. A pin 17,19 extending across each of the tubular locating means 9,11 at a lower end to prevent the vertical members from sliding all the way through.

FIG. 2 illustrates the guard assembly 21 in place in the fixing brackets 3,5. The guard assembly 21 is formed by the two vertical members 23,25 which stand upright in respective fixing brackets 3,5, and three horizontal members 27,29,31 which are disposed between the vertical members 23,25.

The vertical members 23,25 are typically of a steel construction, such as standard scaffolding poles, and the horizontal members 27,29,31 are typically of an aluminium construction. The reason being that the upright members 23,25 are required to have a high degree of rigidity and resilience to prevent the guard assembly 21 from giving way, but the weight of the assembly 21 overall can be kept to a minimum by using lightweight horizontal members 27,29,31 which do not necessarily have to be as resilient as the vertical members 23,25.

To move the guard assembly 21 into and out of place, a sling 33 and shackle 35 assembly 37 is attached at each end to the top ends 39,41 of opposing vertical members 23,25 (as illustrated in FIG. 3). A crane or other lifting apparatus can therefore be employed to lift the guard assembly 21 and reposition it as appropriate. Other means of lifting are envisaged, for example attachment of lifting straps to the topmost ends of one or more of the vertical members, again making use of a crane or other lifting apparatus to lift the guard assembly out of the fixing brackets.

FIGS. 4, 5 and 6 illustrate in further detail the fixing bracket 3 and the vertical member 23 and their interconnection. The fixing bracket 3 comprises a tubular member 39 which has an internal diameter greater than the outer diameter of the vertical member 23, welded to a rectangular plate 41. The rectangular plate 41 is bolted onto the side face 7 of the floor/ceiling panel (or floor cassette) by way of large bolts 43,45 passed through a corresponding back plate 47 and secured by appropriately sized wing nuts 49,51.

Similar tubular members 53,55,57 are disposed horizontally and form locating means on the vertical member 23 to allow the horizontal members 27,29,31 to locate therethrough and thus extend between vertical members 23,25 by virtue of corresponding locating means on the other vertical member 25. The vertical spacing in this example is selected to be 500 mm so as to conform to the relevant safety standards. Thumb screws 59 are provided to lock the horizontal members 27,29,31 in place and prevent sliding through the locating means 53,55,57. FIG. 8 illustrates a front view of the vertical member 23 showing the tubular form of locating means 53,55,57.

The horizontal locating means 53,55,57 may be adjustable in height to allow them to conform to whichever health and safety standards apply at the time or in the locale or the specific circumstances. Also, the vertical members 23,25 may be long enough to allow edge protection to extend to e height above the waist height or even head height of the workers for an even greater degree of protection, in which case even more horizontal members can be put in place.

The utility of the present invention is best illustrated by practical example. With reference to FIG. 7, a portion of a timber kit construction 61 is presented. In the construction of a two-storey house for example, foundations are generally laid and prepared for the laying of a number of floor panels (or floor cassettes) 63 which piece together to form the floor of the house. Generally, this also provides a floor surface 65 suitable for walking on and also for staging further construction steps.

Wall panels 67 are then brought in and moved into a vertical position in which they are secured to the floor panels 63 and adjacent wall panels 69. Once this has been accomplished round the perimeter of the floor area 63, and any internal wall panels 67,69 fixed, the next level of floor or ceiling panels 71 may be put in place.

Typically this stage would require the erection of scaffolding around the entire building to provide edge protection for the workers. However, floor panels 71 in accordance with the present invention are provided with fixing brackets 103,105 which face outwards from the house when put in place. Using the strap and shackle arrangement discussed above, an assembled guard assembly 121 is lifted into place and located in the corresponding fixing brackets 103,105.

This floor 71 is now provided with edge protection without the need for the assembly of a large scaffolding arrangement around the perimeter. Workers are now able to work quickly and, importantly, within the health and safety guidelines, and erect the next level of wall panels 73. Once these are all fixed in place, the edge protection at the first floor level is no longer required and by virtue again of the strap and shackle arrangement the guard assembly 121 can be lifted away, and optionally up to the next level where similar fixing brackets are provided by a second floor of floor panels. This process can repeat indefinitely, for as many storeys as required, until the work is complete.

Note that it is also possible, and in many cases more desirable, to put the guard assemblies 121 in place on the floor panels (e.g. 71) before lifting the floor panels into place on the timber kit erection—in which case edge protection is provided as soon as each floor is in position. This allows workers on the timber kit to quickly begin work. Again, once the wall panels (e.g. 73) have been erected and fixed in place, the guard assemblies can be lifted off with the sling and shackle assemblies provided.

Regardless of the number of floors to be constructed, the number of guard assemblies required remains the same, and the prohibitive cost of scaffolding hire or purchase is avoided. Furthermore, the increasingly significant time taken for assembly of scaffolding as the height of the construction increases is avoided, and a significant improvement in the time taken from start to finish of a timber kit construction program is achieved. The advantages are clear when considering that a typical multi-storey building might require a large amount of scaffolding to be erected, then kick plates and safety rails and the like put in place, prior to work commencing, whereas the present invention allows edge protection to be provided at each level as and when required.

FIG. 9 illustrates an alternative vertical member 123 in which the locating means 153,155 are formed by rings rather than tubular members. The rings 153,155 are welded to the vertical member 123. The rings 153,155 offer a number of advantages over using tubular members. For example, if two vertical members are out of alignment, either vertically or if one of the members is twisted or rotated relative to the other, it is still relatively easy to locate a horizontal member. In the case where the locating means are tubular members, corresponding tubular members require a higher degree of alignment. Therefore by using rings 153,155 the tolerance for manufacturing alignment errors is much higher. In addition, using rings 153,155 allows the weight of the vertical members to be significantly reduced, and the physical dimensions are also reduced.

FIG. 10 illustrates how the overlap of two guard assemblies 221, 222 can be achieved so as to avoid compromising safety at a corner. If the height of the horizontal members on a pair of guard assemblies are the same, at a corner they will only be able to abut one another to close off the corner. Any movement of the guard assemblies may therefore create a dangerous opening through which a person could fall.

The illustrated identical vertical members 223 and 224 each have three equally spaced locating means 253,255,257 and 254,256,258 (respectively) located at the same vertical position on each of the members 223,224. However, the distance A between locating means 257,258 and the end of their respective members 223,224 is larger than distance B between the locating means 253,254 at the opposite end of the members 223,224. As a result, when two identical members 223,224 are placed in brackets 203,204 with one of the members inverted, the locating means 253,255,257 and 254,256,258 do not coincide vertically and as such the horizontal members can overlap at the corner.

FIGS. 11 (a) and (b) illustrate schematically an alternative fixing bracket 301 which comprises a single threaded member 303 which in use extends through a side face of a floor panel and is held in place by bolt member 305. The bolt member 305 has a cup section 307 which engages the side face of the floor panel and is connected to a winged portion 309 which allows the bolt member 305 to be tightened (and loosened) easily. A tubular member 311 provides a means for locating a vertical member (not shown, but which may be of any kind described or envisaged herein), and a spacer 313 allows the vertical member to be held slightly away from the side face of the floor panel to avoid unnecessary contact therebetween. The advantage of the single threaded member is that there is a degree of flexibility in that the tubular member 311 can be rotated slightly if need be to accept a vertical member of a guard assembly. It is also quicker to attach and to de-attach after use.

FIG. 12 illustrates schematically a roof locating bracket 401 having an elongate right angled support section 403 and a sloping section 405. In use, the support section 403 is fixedly attached to a corner of the topmost section 407 of a timber kit erection, typically the upper end of a first floor wall panel. The sloping section 405 is sloped so as to guide a roof section 409 into place on top of the timber kit erection without the need to move the roof section 409 about for optimal placement. Typically, a roof locating bracket 401 is placed at each of four corners on the topmost wall panels, and as the roof section 409 is lowered (in the direction of arrows X) it will engage one or more of the locating brackets 401 which, by means of the sloped portion 405, guide the roof section into place (in the direction of arrows Y).

Not only does the roof locating bracket 401 assist in the proper location of the roof section 409 onto a timber kit erection, but the length of the sloping section 405 actually allows for a greater tolerance of errors in initial positioning when the roof section 409 is being lowered into place. Finally, the roof locating brackets 401 can be removed and the roof section 409 fixedly attached to the timber kit erection. It is also envisaged that in addition to assisting in the proper location of roof sections, the locating bracket may assist in the proper location of floor or ceiling panels or floor cassettes which may have a hollow underside or at least one hollow section or channel with which the locating bracket could interact so as to properly locate said floor cassette atop a peripheral structure (e.g. supporting walls).

FIG. 13 illustrates schematically alternative vertical members 523, 623, and FIG. 14 illustrates schematically use of such a member 523 in a guard assembly 521.

Vertical member 523 (FIG. 13(a) and FIG. 14) again typically comprises a steel scaffolding pole with locating means 553,555,557 for locating corresponding horizontal members 527,529,531 between two or more similar vertical members 523 (as shown in FIG. 14). The locating means 553,555,557 in this embodiment is formed by a plate having an L-shaped cross section which is welded onto the vertical member 523, and thus forms a channel between the plate and the member 523. This channel is sized to accommodate the horizontal member 527,529,531 (which, as in previous examples, is typically an elongate aluminium tubing).

When in the channel, it will be readily understood that gravity will cause the horizontal member 527,529,531 to rest at the bottom of the channel. However, the channel itself provides the horizontal member 527,529,531 with significantly greater freedom of movement in the vertical direction which not only makes locating horizontal members 527,529,531 across two or more vertical members 523 much easier than in embodiments where the locating means is sized more closely to that of a cross section of the horizontal members (for example, rather than having to thread the horizontal members from the side through a number of tubular members such as 53,55,57 in FIGS. 4,5,6 the horizontal members can in fact be put in place from the front and drop into the channels).

Furthermore, the use of such locating means results in greater flexibility in what can be used to form the horizontal members of a guard assembly. FIG. 13(b) shows an alternative embodiment in which a vertical member 623 having locating means 653,655,657 forms channels which can accommodate timber slats 627,629,631 as an alternative to aluminium tubulars. This is another useful alternative as such wooden slats 627,629,631 are readily available, especially on construction sites where they are used for a variety of purposes.

FIG. 14 shows another advantage of the channel-based system of providing a guard assembly 521. Floor cassette 501 is, similarly to embodiments described above, provided with three locating brackets 503 for locating three vertical members 523. Horizontal members 527,529,531 are located across the vertical members 523 in the channels formed by locating means 553,555,557. The depth of these channels is typically such that the horizontal members 527,529,531 are not prone to being removed by accident (e.g. such that a bump or other expected contact would not cause them to exit the channels thus compromising safety). However, the design is such that the horizontal members 527,529,531 can be deliberately removed with ease.

By fixing a removal means 533 such as a sling and shackle assembly or simple connecting straps to the topmost end of the outer vertical members 523 (as illustrated), the guard assembly can be lifted from the floor cassette 501. In doing so, the central vertical member 523 remains in place as the horizontal members 527,529,531 are able to move upwards and out of the corresponding locating means 553,555,557 provided thereon (see FIG. 14(b)). The remaining vertical member 523 can then be removed separately.

This overcomes a particular problem which arises when the horizontal members 527,529,531 are capable of a degree of flex along their length. If the locating means do not allow the movement that the channels in this embodiment provide, lifting of the guard assembly often causes angular displacement of at least the outermost vertical members. This angular displacement results in increasing frictional contact between the lower end of the vertical members and the inner surface of the corresponding locating brackets which not only can cause damage to either component but can render removal difficult or indeed impossible without increased pulling power (which itself may cause further damage).

In summary, aspects of the present invention will allow a timber kit construction to be erected without the requirement for scaffolding to be in place, and enjoy the benefits that are afforded as a result, not least in time and cost savings.

Furthermore, other aspects of the present invention allow the placement of a timber kit roof onto a timber kit construction in such a way that the roof is located safely, precisely, and with relative ease.

Using aspects of the present invention it is foreseen that a timber kit and roof erection procedure could be carried out in a timescale on the order of days or even hours. When compared with conventional methods where factors such as availability of scaffolding, late deliveries, necessary alterations to accommodate different trades etc. can stretch erection times into several weeks or even months, the benefits of aspects of the present invention are immediately apparent.

From the point of view of safety, each intermediate floor (and roof) structure can be constructed at ground level, removing the risk of a fall from height. When the floors are then lifted into place edge protection is available immediately to prevent falls from height. This risk is further reduced by minimising the amount of time a timber kit erector has to spend at any height. Also, as each floor is put in place, other trades can begin working on the lower floors.

Further modifications and improvements may be added without departing from the scope of the invention herein described. For example, where the invention has been described with reference to a two-storey building, the invention is suitable for multiple-storey buildings of any number of floors, or in fact any application where edge protection is required.

1. A method for providing edge protection for a timber kit erection comprising the steps of:
fixedly locating one or more fixing brackets on an outer face of a timber kit floor panel;
removeably locating a guard assembly in the one or more fixing brackets before lifting the floor panel into place; and
lifting the floor panel into place while the guard assembly is located in the one or more fixing brackets.

2. A method as claimed in claim 1, further comprising the step of removing the guard assembly once one or more wall panels have been erected on the floor panel.

3. A method as claimed in claim 2 wherein, the guard assembly is removed by lifting with a sling and shackle assembly.

4. A method as claimed in claim 3 wherein, the method is repeated for as many floors as required.

5. An edge protection apparatus for timber kit erections, the edge protection apparatus comprising:
one or more fixing brackets; and
a guard assembly;
wherein the one or more fixing brackets are adapted to be located on an outer face of a floor panel of the timber kit; and
the one or more fixing brackets further adapted to removeably locate the guard assembly.

6. An apparatus as claimed in claim 5 wherein, the guard assembly comprises two or more upright members and one or more horizontal members disposed therebetween.

7. An apparatus as claimed in claim 6 wherein, the two or more upright members each comprise one or more horizontal member locating means adapted to removably locate the one or more horizontal members therebetween.

8. An apparatus as claimed in claim 7 wherein, the two or more upright members each comprise three horizontal member locating means separated so as to locate three horizontal members therebetween with a vertical spacing of 500 mm.

9. An apparatus as claimed in claim 7 wherein, the one or more horizontal member locating means are moveable so as to adjust the separation between adjacent horizontal members.

10. An apparatus as claimed in claim 7 wherein, the one or more horizontal member locating means are L-shaped in cross section so as to form a channel between the horizontal member locating means and the vertical member.

11. An apparatus as claimed in claim 10 wherein, the channel is open at an upper end thereof so as to allow removal of the horizontal member.

12. An apparatus as claimed in claim 6 wherein, the horizontal members are comprised of timber.

13. An apparatus as claimed in claim 5 wherein, the guard assembly further comprises a sling and shackle assembly arranged to permit lifting of the guard assembly by a crane.

14. An apparatus as claimed in claim 5 wherein, each of the fixing brackets comprises an upright member locating means adapted to receive an upright member of the guard assembly.

15. An apparatus as claimed in claim 5 wherein, each of the fixing brackets comprises a plate to which the upright member locating means is attached, the plate having timber kit locating means adapted to fixedly locate the fixing bracket on a timber kit.

16. An apparatus as claimed in claim 15 wherein, each of the fixing brackets further comprises a spacer between the plate and the upright member locating means.

17. A vertical member adapted for use in the apparatus as claimed in claim 5.

18. A fixing bracket adapted for use in the apparatus as claimed in claim 5.

19. A horizontal member adapted for use in the apparatus as claimed in claim 5.

20. An edge locator which locates an upper section of a timber kit erection on a lower section of a timber kit erection, the edge locator comprising:
a support section; and
a sloping section;
the support section for attachment to the lower section of the timber kit erection and the sloping section adapted to extend above the lower section of the timber kit erection and guide the upper section into place on top of the lower section as it is lowered.

21. The edge locator as claimed in claim 20 wherein, the support section comprises an L-shaped cross section.

22. The edge locator as claimed in claim 20 wherein, the sloping section comprises an L-shaped cross section.

23. The edge locator as claimed in claim 20 wherein, the sloping section is integrally formed with the support section.

24. The edge locator as claimed in claim 20 wherein, the support section is adapted to fixedly locate on the lower section of the timber kit erection.

25. The edge locator as claimed in claim 20 wherein, the sloping section is adapted to correspond with a sloping inner surface of a roof.

26. The edge locator as claimed in claim 20 wherein, the sloping section is adapted to engage a corresponding inner surface of a roof.

27. A method for locating an upper section on a lower section of a timber kit erection using the edge locator of as recited in claim 20, the method comprising the steps of:
fixedly locating one or more edge locators at or near the corners of the lower section of the timber kit erection; and
lowering the upper section onto the one or more edge locators so as to guide the upper section onto the lower section of the timber kit erection.

28. The method as claimed in claim 27 wherein, the method further comprises the step of removing the edge locators when the upper section is in place.

29. The method as claimed in claim 27 wherein, the edge locators are positioned such that the sloping sections thereof extend from the corners of the lower section of the timber kit erection.

30. The method as claimed in claim 27 wherein, lowering the upper section onto the one or more edge locators comprises one or more inner surfaces of the upper section engaging corresponding sloping surfaces of the one or more edge locators.
